(19) United States
(12) Patent Application Publication
(10) Pub. No.: US 2016/0189853 A1
(43) Pub. Date: Jun. 30, 2016

(54) SURFACE-MOUNT INDUCTOR AND METHOD FOR MANUFACTURING THE SAME

(71) Applicant: TOKO, INC., Tsurugashima-shi (JP)

(72) Inventor: Kazuhisa KITAMURA, Tsurugashima-shi (JP)

(21) Appl. No.: 14/979,656

(22) Filed: Dec. 28, 2015

(30) Foreign Application Priority Data
Dec. 26, 2014 (JP) 2014-264167

(51) Int. Cl. H01F 27/28; H01F 41/063

(52) U.S. Cl. CPC H01F 27/2828; H01F 41/063

(57) ABSTRACT

A surface-mount inductor having a coil formed by winding a wire and a molded body for accommodating the coil, wherein the coil includes: a pair of first rolls of wire of a rectangular section which are wound in a two-roll arrangement, both ends of the wire being positioned at their outermost turns;

and a pair of second rolls wound in positions adjacent to and each on opposite sides of the first rolls to partially overlap the first rolls, whereby the ends of the wire are brought out from the outermost turns of the second rolls as lead ends, with winding axis of the coil being parallel with the molded body and the lead ends extending over the surface of the mounting face.

### CROSS REFERENCE TO RELATED APPLICATIONS

This application is based upon and claims the benefit of priority from the prior Japanese Patent Application No. 2014-264167, filed on Dec. 26, 2014, the entire contents of which are incorporated herein by reference.

### BACKGROUND OF THE INVENTION

1. Field of the Invention

The present invention relates to a surface-mount inductor and a method for manufacturing the same.

2. Description of the Related Art

Conventionally, surface-mount inductors whose coils have been coated with thermoplastic sealant (molding material) containing magnetic powder and resin are widely used. For example, JP2003-290992 discloses a method for manufacturing surface-mount inductors using metal pieces as external terminals. The surface-mount inductors have external terminals which are metal pieces welded to lead ends being processed to serve as external terminals.

JP2004-193215 discloses a method for manufacturing surface-mount inductors by coating coils, which is configured by winding a wire having a rectangular section (hereinafter “rectangular wire”), with sealing material. The surface-mount inductor has external terminals which are formed by deforming lead wires of a coil.

### SUMMARY OF THE INVENTION

In a surface-mount inductor disclosed in JP2003-290992, since its coil ends are welded to metal pieces, the contact portions of the coil ends and of the metal pieces are exposed to thermal and mechanical stresses. In addition, contact resistance occurs at the contact portions of the coil ends and metal pieces.

In the surface-mount inductor of JP2004-193215, since the direction of the winding axis of the coil is orthogonal to the wide surface of the rectangular wire, the inner and outer diameters are exposed to mechanical stress during winding.

Further, the surface-mount inductor in JP 2004-193215 is so configured that one lead end goes from its bottom side to the bottom and the other lead end goes from upper side to the bottom.

In this case, because of the difference in the length of the lead wires, the shape of the coil is asymmetrical. The surface-mount inductor incorporating an asymmetrical coil requires a step of marking the polarity of the terminals, since the electric characteristics when inputting in one terminal are different from those when inputting in the other terminal.

Consequently, the present invention aims to provide a surface-mount inductor that incorporates a symmetrical coil, has less mechanical and thermal stresses, eliminates contact resistance between a coil and the external terminals, and provides a method for manufacturing the same.

### Means for Solving the Problem

A surface-mount inductor having a coil formed by winding a wire and a molded body for accommodating the coil, according to the present invention is characterized in that the coil comprises:

a pair of first rolls of wire of a rectangular section which are wound in a two-roll arrangement, both ends of the wire being positioned at their outermost turns; and

a pair of second rolls wound in positions adjacent to and each on opposite sides of the first rolls to partially overlap on the first rolls,

whereby the ends of the wire are brought out from the outermost turn of the second rolls as lead ends, a winding axis of the coil is parallel with the molded body and the lead ends extend over the surface of the mounting face.

A method for manufacturing a surface-mount inductor, according to the present invention is characterized by comprising:

a step of making a coil by forming a pair of first rolls contacting the median portion of the wire having rectangular section to the spindle of a winding machine to wind and positioning both ends of the wire at the outermost turns, by arranging a jig at the central portion of the first rolls, by forming a pair of second rolls on the first rolls at positions each on opposite sides of the first rolls to partially overlap on the first rolls, and by forming lead ends brought out from the outermost turns of the second rolls, and

a step of incorporating the coil inside the molded body,

whereby the coil is incorporated in the molded body, arranging the winding axis to be parallel with the mounting face of the molded body, and the lead ends to extend over the surface of the molded body.

### Effect of the Invention

According to the surface-mount inductor and the manufacturing method of the same as described in the present application, since the lead ends of coil are used as external terminals, the thermal and mechanical stresses are decreased and the contact resistance between the coil and the external terminals are eliminated. Further, since the direction of the winding axis and that of the wide surface of the coil are parallel, the mechanical stress caused at the inner and outer diameter portions may be decreased. In addition, since the coil is wound such that the direction of the mounting face of the surface-mount inductor and the direction of winding axis of the coil are parallel, the shape of the coil may be symmetrical.

Therefore, a surface-mount inductor, which serves to decrease the thermal and mechanical stresses and the contact resistance, and to solve the issue of polarities of electrical characteristics polarity, as well as a method for manufacturing the same can be provided.

### BRIEF DESCRIPTION OF THE DRAWINGS

FIG. 1 is a perspective view of a surface-mount inductor of the first embodiment according to the present invention;

FIGS. 2A, 2B, 2C and 2D show steps in method of winding a coil which is used in the surface-mount inductor of the first embodiment according to the present invention in sequential manner;

FIG. 3 is a perspective view of the block which is used in the first embodiment according to the present invention;

FIG. 4 is a plan view of the mounting face of the block which is used in the surface-mount inductor of the first embodiment according to the present invention;

FIGS. 5A, 5B and 5C show steps for manufacturing the surface-mount inductor of the first embodiment according to the present invention, FIG. 5A showing the state before blocks being fitted, FIG. 5B showing the attached blocks, and FIG. 5C showing the state of the mounting face after fitting;

FIG. 6 is a partial sectional view showing the method of manufacturing of the surface-mount inductor of the first embodiment according to the present invention;

FIG. 7 shows the step for fitting the two blocks and the coil of the first embodiment according to the present invention;

FIG. 8 is a perspective view showing the magnetic core of the second embodiment according to the present invention; and

FIG. 9 is a perspective view showing the surface-mount inductor according to the present invention.

### DETAILED DESCRIPTION OF THE INVENTION

### Embodiment 1

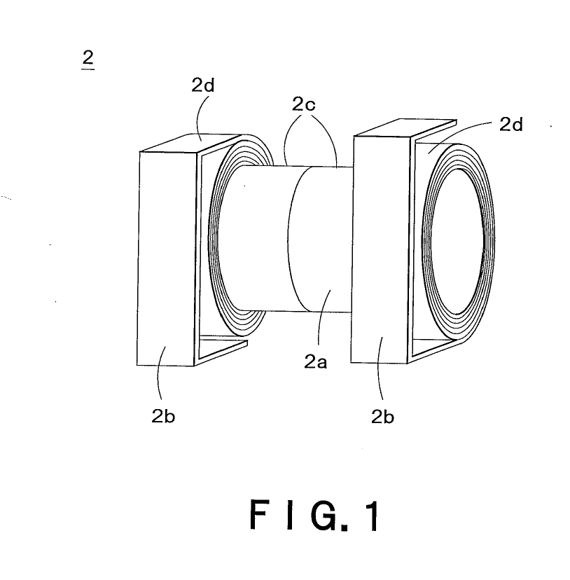

The first embodiment of a surface mount inductor according to the present invention will now be described with reference to FIGS. 1 through 7. As shown in FIG. 1, a coil 2 is a coreless (empty core) coil having symmetrical profile when viewed from a direction orthogonal to the axial line. The coil 2 has two first rolls 2c, which are such configured that both ends of a rectangular wire are positioned at the outermost turn and are positioned adjacently along the winding axis, and two second rolls 2d, which are configured as two rolls, the inner diameters of which are equal to or larger than the outer diameters of the first rolls 2c, and the second rolls 2d are positioned adjacent to the first rolls 2c on opposite sides along the winding axis of the coil 2.

From the outermost turn of the second rolls 2d, the lead ends 2b, which are the ends of the rectangular wire, are brought to the extending direction of the outer peripheries. The respective lead ends 2b are brought toward opposite directions from the winding axis and the end portions are formed to be U-shaped to shelter the outermost turn of the coil 2.

The coil 2 thus formed does not suffer from mechanical stress around the inner and outer diameter portions when winding, because the direction of the wide surfaces 2a and the direction of the rectangular wire are parallel.

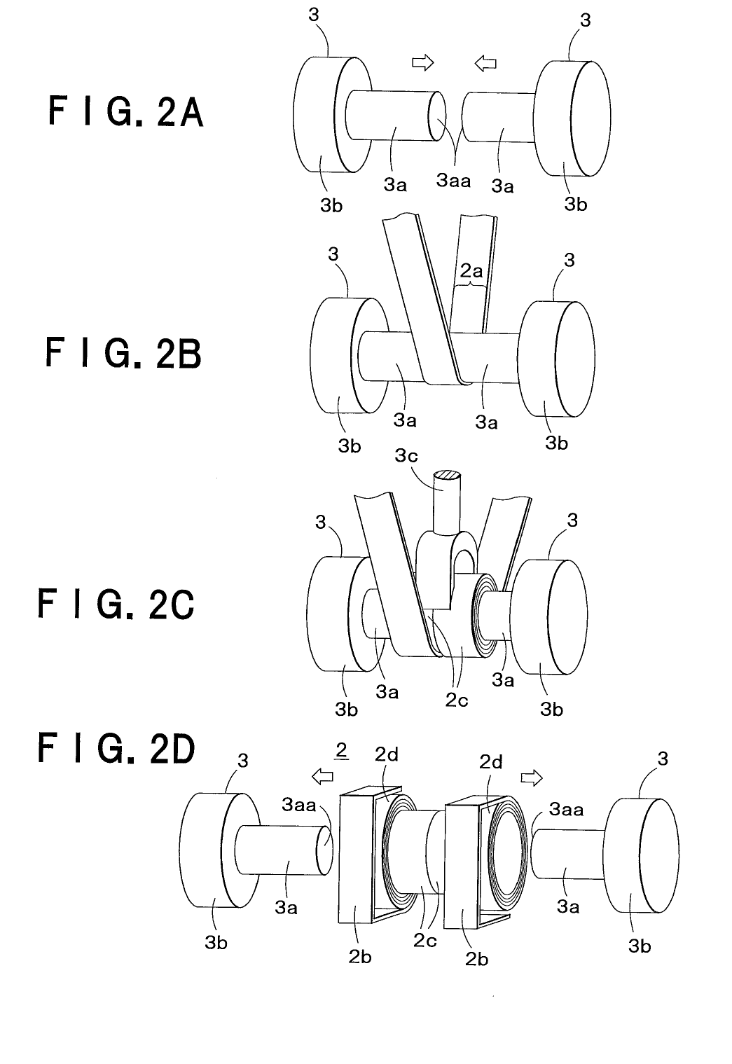

FIGS. 2A through 2D show a method for winding the coil 2. A winding machine (not shown) is used to wind the coil 2. The winding machine provided with a pair of spindles 3 each having a winding core 3a and a base portion 3b (FIG. 2A). A rectangular wire with insulation is so arranged that the wide surface 2a is in contact with the winding core 3a (FIG. 2B), and the rectangular wire is wound on the winding core 3a by using a jig 3c, which has a C-shaped mouth at the tip, to form the coil 2.

The pair of the spindles 3 has a cylindrical winding core 3a, and a cylindrical base portion 3b, respectively. The base portions 3b have a larger outer diameter than the outer diameter of the winding cores 3a, and are arranged to be coaxial with and adjacent to the winding cores 3a. The jig 3c has the C-shaped mouth at its tip, and the thickness of the jig 3c is the same as the width of the wide surface 2a of the rectangular wire used in the coil 2.

The length of the winding core 3a in the direction of the winding axis is longer than the width of the rectangular wire used in the coil 2. A tip 3aa of the spindle 3 is the end surface of the winding core 3a opposite to the base portion 3b.

Firstly, the two spindles 3 are positioned in a manner that the spindle tips 3aa face each other, as shown in FIG. 2A.

Then, as shown in FIG. 2B, the wide surface 2a of the median portion of the rectangular wire is put in contact with the winding cores 3a. The ends of the rectangular wire are repetitively wound in opposite directions around the winding cores 3a. Thus, two first rolls 2c are formed in two-roll arrangement in the direction of the winding axis, rolls being positioned adjacent to each other. And, as shown in FIG. 2C, the jig 3c is so positioned that the tip 3aa is at the center of the first rolls 2c of two-roll arrangement so as to prevent to wind the rectangular wire on the portion where the jig 3c contacts the first rolls 2c.

And then, the rectangular wire is wound on the first rolls 2c to be shifted to each other in opposite directions in partially overlapping manner to form a second rolls 2d at both sides of the jig 3c. After that, the rectangular wire is pulled from the outermost turn of the second rolls 2d to form the lead ends 2b (see FIG. 2D).

The lead ends 2b are pulled from the outermost turn of the coil 2 in its extended directions oppositely each other and the ends thereof are bent to form U-shaped portions. The coil 2 is heated and solidified, and then is removed thereafter from the spindles 3, as shown in FIG. 2D, to manufacture the coil 2 which is symmetrical relative to a direction orthogonal to the winding axis.

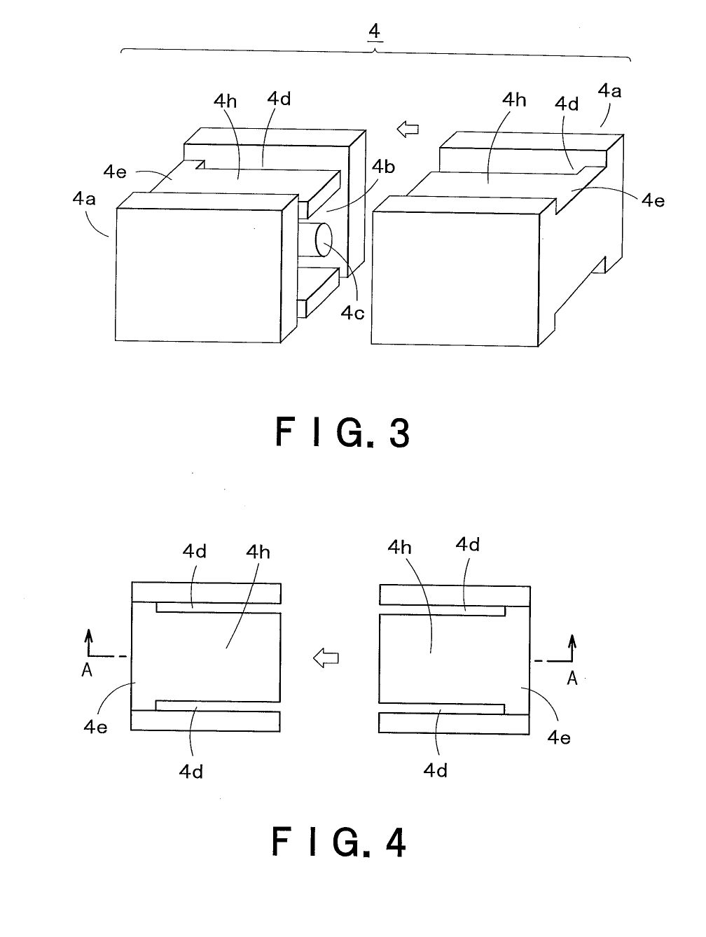

A molded body 4 which includes the coil 2 will be described in reference to FIG. 3. The molded body 4 is formed by fitting two blocks 4a. The block 4a is formed by applying pressure to sealant which contains filler with metallic magnetic powder and epoxy resin.

As shown in FIG. 3, the blocks 4a are rectangular parallelepipeds having open end surface and a space 4b to accommodate the coil 2 inside. The cylindrical protrusion 4c to pass through the central hole of the coil 2 extends from the central portion of inner wall of the opposite end surface toward the open end surface. The upper and bottom surfaces of the block 4a have the same shape, with one of them serving as the mounting face 4e (the upper surface in FIG. 3).

As shown in FIG. 4, the mounting faces 4e are rectangular, with the open surface forming the short side and the other surface forming the long side. At both short sides of the mounting face 4e, the elongated slits 4d for bringing out the lead ends 2b therethrough are provided.

The portion of the mounting face 4e bordered by the slits 4d forms the supporting portion 4h which serves to support the lead ends 2b of the coil 2. Namely, the two slits 4d and the supporting portion 4h constitutes the U-shaped supporting structure to fit to the sectional shape of the lead ends 2b (FIGS. 2A-2D).

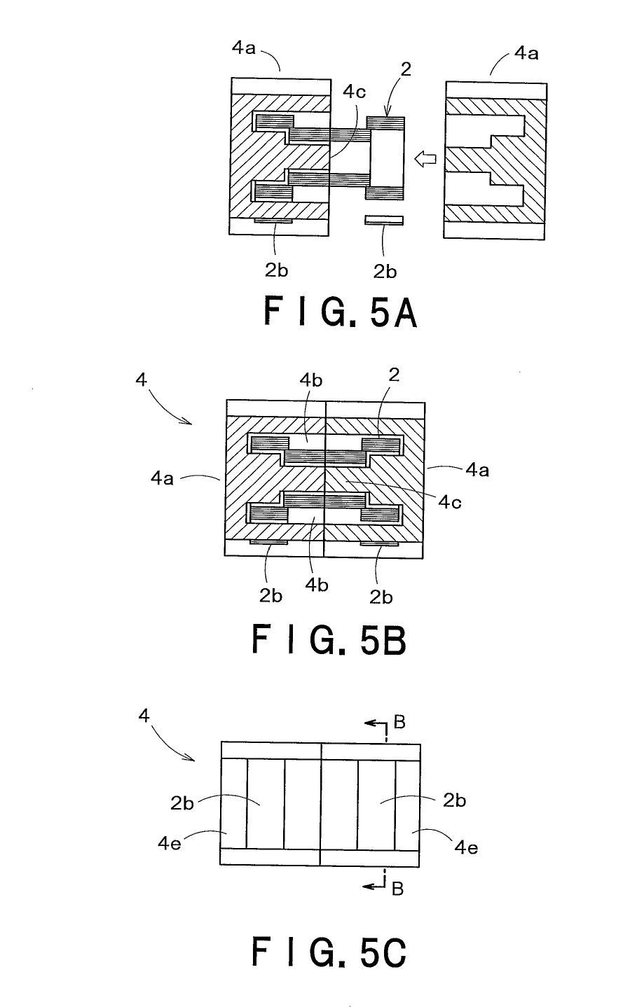

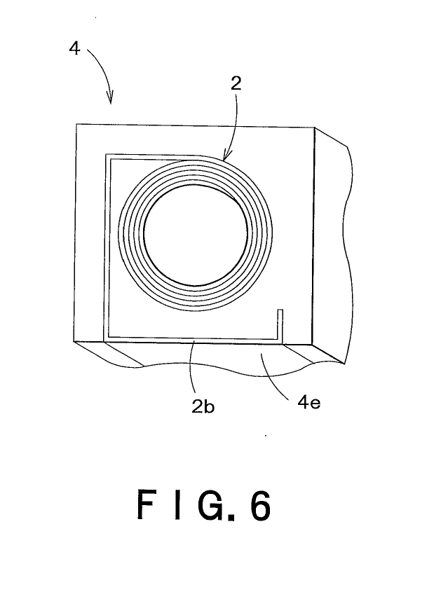

Next, the method for sealing the coil are described, referring to FIGS. 5A-5C,.

FIGS. 5A and 5B are sectional views along the line A-A in FIG. 4, namely a sectional view parallel with the mounting face 4e, while FIG. 5C is a plan view of the mounting face 4e.

As shown in FIG. 5A, the blocks 4a are arranged on both sides of the direction of the axis of the coil 2 in a manner that the open sides face each other. In one of the blocks 4a, the protrusion 4c of the block is inserted into the central hole of the coil 2 and the lead end 2b is pulled out through the slit 4d of the mounting face 4e.

FIG. 5B shows a state that where other block 4a is fitted from the direction of the winding axis of the coil 2. The space 4b for accommodating the coil 2 is provided in the inside the block 4a. The coil 2 is accommodated inside the two blocks 4a with the protrusions 4c being inserted into the central portion of the coil 2. The lead end 2b is brought out through one of the two slits 4d so as to be parallel with the short side of the mounting face 4e and inserted into the other slit 4d to be U-shaped in section.

In this state, the two blocks 4a which incorporate the coil 2 are pressed in a mold and then heated (thermocompressed). Thus, as shown in FIG. 5C, the lead ends 2b of the coil 2 are fixed to the mounting face 4e so as to be visible, and the two blocks 4a are solidified to form a molded body 4 sealing the coil 2 inside.

FIG. 6 shows the step for forming the external terminals by processing the lead ends 2b. FIG. 6 is the sectional view along the line B-B in FIG. 5C.

The lead ends 2b, which are embedded in the mounting face 4e, and the portion of the lead ends exposed are machined by laser beam to remove the insulation cover therefrom. Because of the flatness of the rectangular wire, the settings for laser processing are uncomplicated. As the laser processing is used to remove the insulation of one face, the process does not require to be repeated. The lead ends 2b are simultaneously sputtered with predetermined ratio of Ni and Cu to form a Ni—Cu layer, subsequently sputtering with Sn to form a Sn layer so as to process the lead ends 2b into the external terminals. Because of using the rectangular wire, the adhesiveness to other components may be improved, compared to the case of using a round wire. In addition, the evenness of the mounting face 4e can be raised.

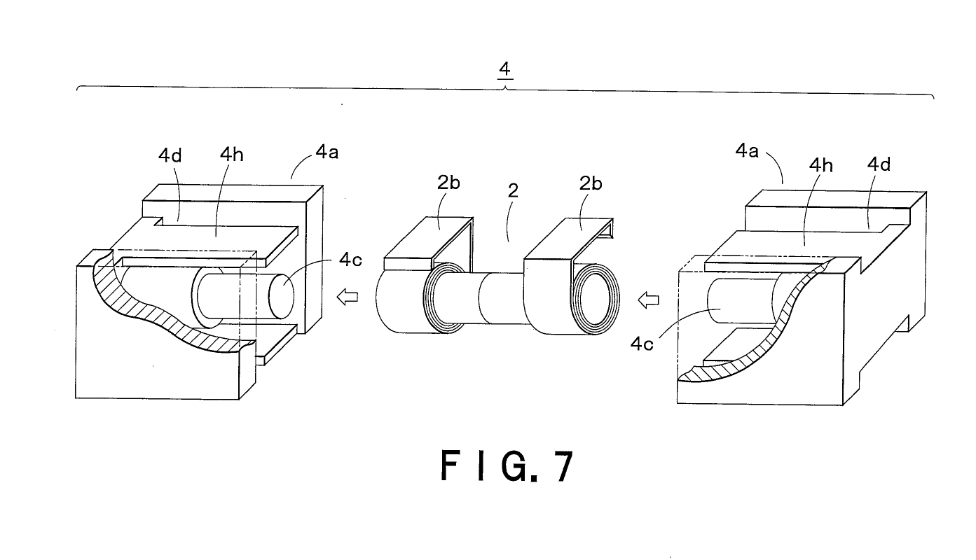

FIG. 7 shows the steps for fitting the two blocks 4a and the coil 2 according to the first embodiment of the present invention. The left end of the coil 2 is inserted into the block 4a (left side in FIG. 7). For this process, the center of the coil 2 is positioned on the protrusion 4c of the block 4a, and the lead end 2b (left side in FIG. 7) of the coil 2 is positioned to be mounted on the supporting portion 4h of the block 4a. Thus, the coil 2 is pressed toward the left as indicated by the arrow in FIG. 7 so that the coil 2 is fitted with the block 4a on the left in FIG. 7.

Then, the block 4a on the right side in FIG. 7 is fitted with the left side block 4a which is already fitted with the coil 2. For such a process, the central hole of the coil 2 is positioned on the protrusion 4c of the block 4a at the right side in FIG. 7, and the right-side supporting portion 4h is aligned with the right-side lead end 2b, and then the block 4a on the right side in FIG. 7 is pressed toward the left side as shown by the arrow. As a result, the U-shaped portion of the lead ends 2b holds the supporting portion 4h and is in turn supported by the supporting portions 4h.

Accordingly, the two blocks 4a are joined via the coil 2 so the three of them are integrated together. As described before referring to FIG. 5, the molded body 4 is formed by thermocompressing.

Since the surface-mount inductor produced as described above has an entirely symmetrical shape, the electric characteristics are the same regardless which of the input terminals receives an input. Therefore, there is no need for marking so as to discriminate terminals thus manufacturing cost can be reduced.

### Embodiment 2

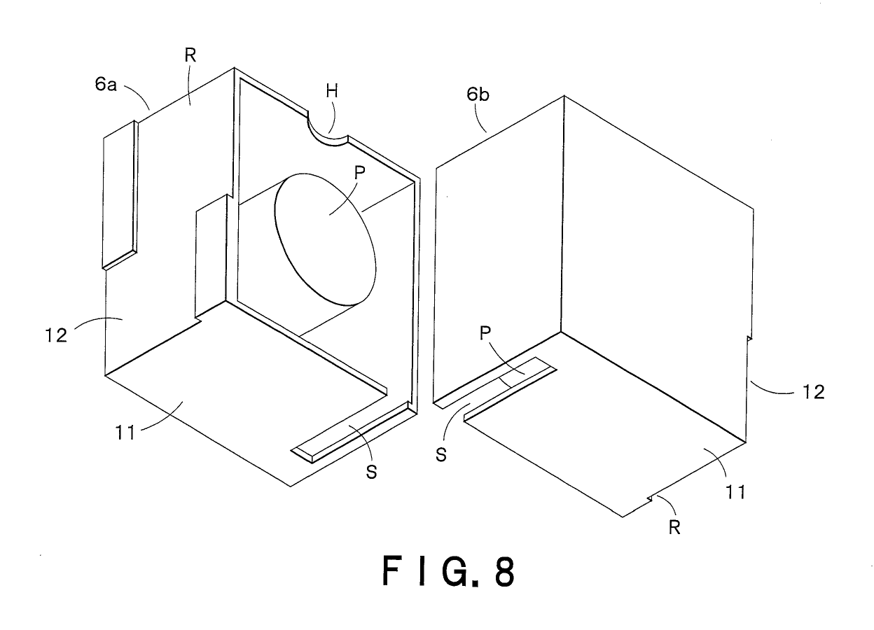

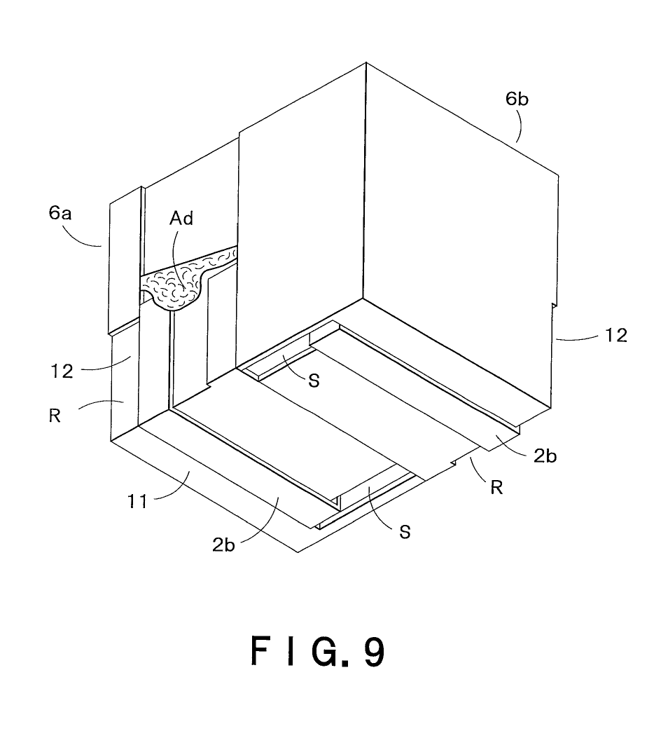

The surface-mount inductor and the method for manufacturing the same according to the second embodiment of the present invention are described in reference to FIGS. 8 and 9. The second embodiment is a surface-mount inductor incorporating the coil 2 in a molded body consisting of a magnetic core and sealant.

Firstly, the coil 2 is formed according to the same method as the one used for the first embodiment. Then, as shown in FIG. 8, a pair of bottomed magnetic cores 6a, 6b which includes a protrusion P to be inserted into the central hole of the coil 2, a slit S for bringing out the lead ends 2b to the mounting face 11, a hole H provided at the aperture side of a surface opposing the mounting face 11 and a recess R formed on the auxiliary surface is installed on the coil 2. The pair of bottomed magnetic cores 6a, 6b is installed on the coil 2 in a manner that the protrusion P is inserted into the central hole of the coil 2 from both sides and that the lead ends 2b are inserted into the slit S.

Further, the lead ends 2b of the coil 2 which is accommodated in the pair of bottomed cores 6a, 6b, are bent along the magnetic cores 6a, 6b to extend over the mounting face 11 and the surface 12 (“auxiliary surface 12” hereinafter) adjacent to the mounting face 11. The portions of the lead ends 2b extending over the auxiliary surface 12 of the magnetic cores 6a, 6b are bent upward from the mounting face of the magnetic cores 6a, 6b and are arranged in the recess R formed on the auxiliary surface 12.

And then, as shown in FIG. 9, the ends of the lead ends of the coil 2 arranged in the recess R are secured thereto by means of an adhesive Ad.

Furthermore, the magnetic cores 6a, 6b housing the coil 2 are arranged in a mold, directing the mounting face 11 of the magnetic cores 6a, 6b upward, and sealant is poured into the mold. The molding resin is poured to expose the mounting face 11 of the magnetic cores 6a, 6b. Thanks to the provision of the slit S and of the hole H, the magnetic cores 6a, 6b may be completely filled with the sealant so that the sealant is filled up to the same level as the mounting face 11 in the slit S of the magnetic cores 6a, 6b.

Subsequently, hardening the sealant and taking out from the mold, a molded body 4 is formed. In the molded body 4, the coil 2 is incorporated in a manner that the winding axis is parallel with the mounting face 11, and the lead ends of the coil 2 extend over the mounting face and the auxiliary surface, and the magnetic cores 6a, 6b are entirely sealed by the sealant exposing the mounting face 11 of the magnetic cores 6a, 6b, and the lead ends 2b are sealed by the sealant.

The lead ends 2b of the coil 2 extending over the mounting face 4e of the molded body 4, which consists of the mounting faces of the magnetic cores 6a, 6b, are used as external terminals, the insulation coating being removed. Electrodes covering the portions of lead ends 2b, which are extending over the mounting face 4e of the molded body 4, are provided in order to form the external terminals.

Although the surface-mount inductor and the method for manufacturing the same has been described in relation to the embodiments, the present invention should not be limited thereto. A part of blocks may be substituted by a magnetic core, and a part of magnetic cores may be substituted by a block. The mounting face of the magnetic core may be covered with the sealant to expose the surface of the lead ends. Further, the sealant may include ferrite powder.

Furthermore, the molded body may have a pair of metal bodies. The pair of metal bodies is so formed that which covers the upper, end surfaces and the side surfaces adjacent to the upper and end surfaces, and that the lower ends thereof reach the same level as the surface of the external terminals provided at the mounting face of the molded body. The pair of metal bodies is attached at the both ends of the molded body to make a gap between the metal body and the external terminals. In this case, the metal bodies are attached not to contact mutually.

When mounting and soldering the surface-mount inductor described above on a wiring board, the gaps between the metal bodies and the external terminals may be filled with solder fillet so as to firmly secure the surface-mount inductor to the board. In addition, external noise can be prevented.

Further, in the second embodiment, the mounting face of the magnetic core may be covered with the sealant to expose the surface of the lead ends.

### Explanation of Codes

1 surface-mount inductor
2 coil
2a wide surface
2b lead end
2c first roll
2d second roll
3 spindle
3a winding core
3aa tip
3b base portion
3c jig
4 molded body
4a block
4b space
4c protrusion
4d slit
4e mounting face
5 external terminal
6a, 6b magnetic core
11 mounting face
12 auxiliary surface
P protrusion
S slit
H hole
R recess
Ad adhesive

What is claimed is:

1. A surface-mount inductor having a coil formed by winding a wire and a molded body for accommodating the coil, wherein
the coil comprises:
a pair of first rolls of wire of a rectangular section which are wound in a two-roll arrangement, both ends of the wire being positioned at their outermost turns; and
a pair of second rolls wound in positions adjacent to and each on opposite sides of the first rolls to partially overlap on the first rolls,
whereby the ends of the wire are brought out from the outermost turn of the second rolls as lead ends, a winding axis of the coil is parallel with the molded body and the lead ends extend over the surface of the mounting face.

2. A method for manufacturing a surface-mount inductor including a coil formed by winding a wire and a molded body for accommodating the coil, comprising:
a step of making a coil by forming a pair of first rolls contacting the median portion of the wire having rectangular section to the spindle of a winding machine to wind and positioning both ends of the wire at the outermost turns, by arranging a jig at the central portion of the first rolls, by forming a pair of second rolls on the first rolls at positions each on opposite sides of the first rolls to partially overlap on the first rolls, and by forming lead ends brought out from the outermost turns of the second rolls, and
a step of incorporating the coil inside the molded body,
whereby the coil is incorporated in the molded body, arranging the winding axis to be parallel with the mounting face of the molded body, and the lead ends to extend over the surface of the molded body.

3. The method for manufacturing the surface-mount inductor according to claim 2, wherein
a pair of second rolls is formed at both sides of the jig on the first rolls partially overlapping thereon.
